(19) United States
(12) Patent Application Publication
(10) Pub. No.: US 2004/0090908 A1
(43) Pub. Date: May 13, 2004

(54) Initial synchronizing method of mobile communication system

(75) Inventor: Bog Hyun Jang, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/691,704

(22) Filed: Oct. 24, 2003

(30) Foreign Application Priority Data
Oct. 28, 2002 (KR) 65963/2002

(51) Int. Cl. H04J 11/00

(52) U.S. Cl. 370/208; 370/342

(57) ABSTRACT

In an initial synchronizing method of a mobile communication system capable of reducing an initial synchronous retrieval time of a system by providing a condition in correlation value operation or simplifying data combination or retrieving a candidate region in which a synchronous code may exist and performing operation about only several samples of the region, by calculating correlation values by extracting baseband data by dividing it into a certain block units and operating the extracted baseband data with synchronous data; and detecting baseband data having a correlation value greater than a preset threshold value by comparing the operated correlation values with the present threshold value, it is possible to reduce operational complexity for initial synchronization and initial synchronous time by not performing operations about all input signals, and accordingly power consumption of a terminal can be reduced.

### BACKGROUND OF THE INVENTION

1. Field of the Invention

The present invention relates to an initial synchronizing method of a mobile communication system, and in particular to an initial synchronizing method of a mobile communication system capable of reducing the time of initial synchronous retrieval of a mobile communication system.

2. Description of the Related Art

A mobile communication system means environment performable communication by connecting a mobile station with a base station wirelessly. Herein, a TD-SCDMA (time division synchronous code division multiple access, or TSM) is one method for making plural mobile stations perform communication simultaneously with limited frequency (or channel) resources used for radio connection.

The TD-SCDMA is developed by combining a NB-TDD (narrow band time division duplexing) CDMA with a GSM (global system for mobile communication), and China adopts it for a standard mobile communication system.

In the TD-SCDMA, radio interface as a layer 1 is the same with that of the NB-TDD method, and the rest superior layers have the same structure with those of the GSM method.

FIG. 1 is a flow chart illustrating an initial cell retrieval method by the TD-SCDMA in accordance with the conventional art.

As depicted in FIG. 1, the initial cell retrieval method by the TD-SCDMA includes receiving information of a base station to which a mobile station itself presently belongs as shown at step S10; discriminating a presently used scrambling code and a basic midamble code as shown at step S20; checking a position of a BCCH (broadcast control channel); and accessing information (namely, information about a common channel having system information) transmitted through the BCCH as shown at step S40.

The initial cell retrieval method by the TD-SCDMA will be described in more detail.

By using a SYNC code to obtain forward synchronous with the base station, the mobile station retrieves a down link pilot time slot. Herein, the mobile station uses at least one matching filter.

For example, the mobile station discriminates a synchronous code thereof from the preset 32-number of synchronous codes. Herein, in order to get simple correlation about a received signal, a 64-tap FIR filter is used to retrieve down link pilot. In more detail, because pilot consists of the 32-number of signals, the 32-number of 64-tap FIR filters are used, herein, although initial synchronous can be obtained, hardware may be intricate, and additional cost may occur.

In the meantime, in order to implement a device for retrieving initial synchronous with one filter, a maximum value is obtained by repeating operations twenty-two times. In more detail, in the software aspect, when a length of a filter tap is long, it means multiplying and adding operations have to be repeatedly performed many times. Accordingly, one correlator performs multiplying and adding operations sixty-four times, and the 32-number of operations are repeatedly performed about all input signals. Herein, if operational speed is not faster than input signal speed, signals greater than one sub fame is stored, and operation is performed thirty-two times.

Accordingly, in the initial cell retrieving process for performing initial synchronous between the base station and the mobile station in accordance with the conventional art, operational complexity is increased, and accordingly time required for initial synchronous and power consumption are increased.

### SUMMARY OF THE INVENTION

In order to solve the above-mentioned problem, it is an object of the present invention to provide an initial synchronizing method of a mobile communication system capable of reducing operational complexity in initial synchronous code retrieval and shortening initial synchronous retrieval time of a system by comparing a threshold value operated in the initial synchronous with a set threshold value.

In order to achieve the above-mentioned object, an initial synchronizing method of a mobile communication system in accordance with the present invention includes operating a correlation value by operating baseband data and synchronous code data; and detecting a correlation value greater than a preset threshold value by comparing the operated correlation value with the preset threshold value.

In order to achieve the above-mentioned object, an initial synchronizing method of a mobile communication system in accordance with the present invention includes calculating correlation values by extracting baseband data by dividing it into a certain block units and operating the extracted baseband data with synchronous data; and detecting baseband data having a correlation value greater than a preset threshold value by comparing the operated correlation values with the present threshold value.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flow chart illustrating an initial cell retrieving method by a TD-SCDMA (time division synchronous code division multiple access, hereinafter referred to as a TSM) in accordance with the conventional art;

FIG. 2 is a flow chart illustrating an embodiment of an initial synchronizing method of a mobile communication system in accordance with the present invention; and

FIG. 3 is a flow chart illustrating another embodiment of an initial synchronizing method of a mobile communication system in accordance with the present invention.

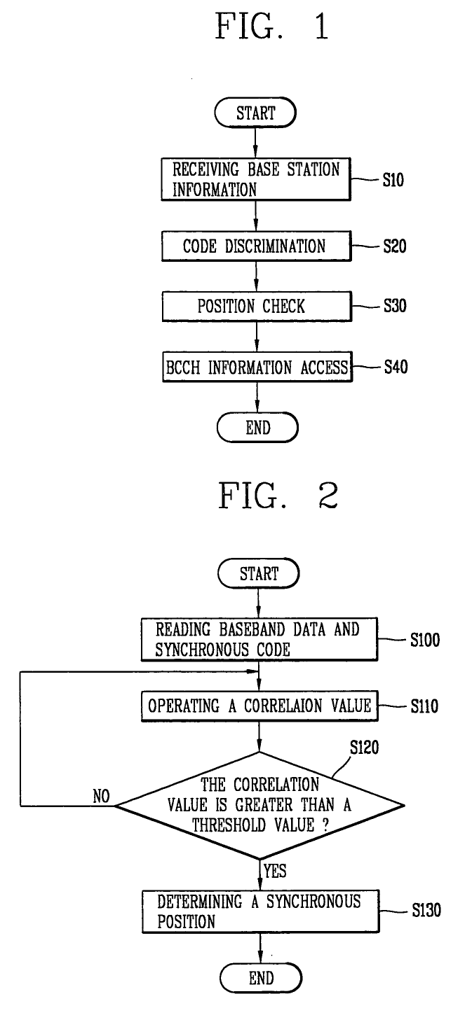

### DETAILED DESCRIPTION OF THE PREFERRED EMBODIMENT

FIG. 2 is a flow chart illustrating an embodiment of an initial synchronizing method of a mobile communication system in accordance with the present invention.

As depicted in FIG. 2, the initial synchronizing method of the mobile communication system in accordance with the present invention includes reading a bsaeband data value and a synchronous data value as shown at step S100; calculating a correlation value by multiplying the baseband data value by the synchronous data value as shown at step S110; detecting a correlation value greater than a present threshold value by comparing the correlation value with a preset threshold value as shown at step S120; and determining a baseband data position of a maximum correlation value correlation values greater than the threshold value as a synchronous position as shown at step S130.

The initial synchronizing method of the mobile communication system will be described in detail.

First, by reading baseband data and synchronous code data passing a matching filter and multiplying real number part and imaginary number part values of the baseband data by real number part and imaginary number part values of the synchronous code data, correlation values are detected. Herein, in the conventional art, by performing correlation value operation according to each combination, operational complexity is incresaed. However, in the present invention, by providing various conditions in correlation value operation or simplifying data combination, operational complexity can be reduced.

In more detail, multiplication of the bsaeband data and synchronous data values can be performed according to various data combinations. However, in order to reduce operational complexity by simplifying data combination, it is more preferable to operate only values in each real number part of the baseband and synchronous code data. In addition, correlation values can be calculated by providing a certain condition to multiplication of the baseband and synchronous code data. For example, when there are various multiplying combinations such as real number unit or imaginary number unit values of the baseband data and real number unit or imaginary number unit values of the synchronous code data, it is possible to reduce operational complexity by providing a certain condition such as using only one combination.

Afterward, by presetting a threshold value, when there are several operated correlation values, only a value greater than the threshold value is detected as a correlation value.

Lastly, by determining a baseband data position having a maximum correlation value among correlation values greater than the threshold value as a synchronous position, an accurate synchronous position is detected.

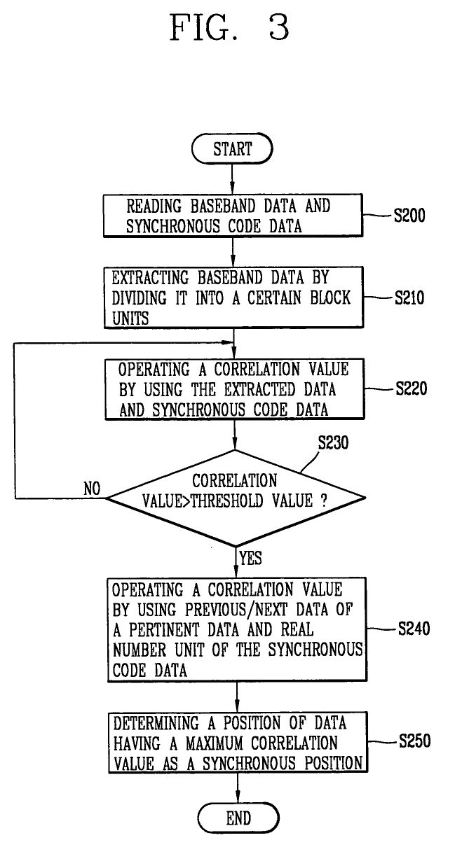

FIG. 3 is a flow chart illustrating another embodiment of an initial synchronizing method of a mobile communication system in accordance with the present invention.

As depicted in FIG. 3, the initial synchronizing method of the mobile communication system in accordance with the another embodiment of the present invention includes reading baseband data and synchronous code data values as shown at step S200; extracting the baseband data by dividing it into a certain block units as shown at step S210; obtaining a correlation value by operating the extracted baseband data and the synchronous code data as shown at step S220; detecting baseband data having a correlation value greater than a preset threshold value by comparing the operated correlation value with the preset threshold value as shown at step S230; operating a correlation value by multiplying previous/next data of the detected baseband data by real number unit of the synchronous code data as shown at step S240; and determining a baseband data position of a maximum correlation value among the operated correlation values as a synchronous position as shown at step S250.

The operation of the initial synchronous method of the mobile communication system will be described in more detail.

First, after reading baseband data and synchronous code data passing the matching filter, the baseband data is extracted by being divided into a certain block units.

For example, the eighth baseband data per each divided baseband datablock unit is extracted.

Next, a correlation value is calculated by using the extracted baseband data and synchronous code data.

For example, operation of the baseband data and synchronous code data can be performed with various data combinations, however, in order to reduce operational complexity by simplifying data combination, it is more preferable to operate only values in each real number part of the baseband and synchronous code data. In addition, by providing a condition in multiplying of the baseband data and synchronous code data value, a correlation value can be calculated more simply. For example, when there are various multiplying combinations such as real number unit or imaginary number unit values of the baseband data and real number unit or imaginary number unit values of the synchronous code data, it is possible to reduce operational complexity by providing a certain condition such as using only one combination.

Afterward, by comparing operated correlation values with the preset threshold value, baseband data having a correlation value greater than the threshold value is detected. In more detail, by presetting a threshold value and detecting only correlation values greater than the threshold value, operational complexity can be reduced.

Lastly, by multiplying previous/next data of the detected baseband data by real number unit of the synchronous code data and determining a baseband data position having a maximum correlation value among correlation values greater than the threshold value as a synchronous position, an accurate synchronous position can be detected.

As described-above, in the present invention, by providing a condition in correlation value operation or simplifying data combination or retrieving a candidate region in which a synchronous code may exist and performing operation on only several samples of the region, it is possible to reduce operational complexity for initial synchronization and initial synchronous time by not performing operations about all input signals, and accordingly power consumption of a terminal can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An initial synchronizing method of a mobile communication system, comprising:
calculating a correlation value by operating baseband data and synchronous code data values; and
detecting a correlation value greater than a preset threshold value by comparing the operated correlation value with a preset threshold value.

2. The method of claim 1, further comprising:
reading baseband data and synchronous code data values; and
determining a baseband data position having a maximum value among correlation values greater than the threshold value as a synchronous position.

3. The method of claim 1, wherein operation of the baseband data and synchronous code data is performed by multiplying real number unit of the baseband data by real number unit of the synchronous code data.

4. The method of claim 1, wherein operation of the baseband data and synchronous code data is performed by using only one combination among combinations of multiplying real number unit or imaginary number unit of the baseband data with real number unit or imaginary number unit of the synchronous code data.

5. The method of claim 1, wherein operation of the baseband data and synchronous code data is for calculating a correlation value by multiplying real number unit and imaginary number unit of the baseband data with real number unit and imaginary number unit of the synchronous code data.

6. An initial synchronizing method of a mobile communication system, comprising:
calculating correlation values by extracting baseband data by dividing it into a certain block units and operating the extracted baseband data with synchronous data; and
detecting baseband data having a correlation value greater than a preset threshold value by comparing the calculated correlation values with the present threshold value.

7. The method of claim 6, further comprising:
reading baseband data and synchronous code data;
calculating correlation values by multiplying previous/next data of the detected baseband data by only real number unit of the synchronous code data; and
determining a baseband data position of a correlation value having a maximum value among the calculated correlation values as a synchronous position.

8. The method of claim 6, wherein operation of the baseband data and synchronous code data is performed by using only real number unit of the baseband data and real number unit of the synchronous code data as data values.

9. The method of claim 6, wherein a correlation value is obtained by multiplying real number unit and imaginary number unit of the baseband data with real number unit and imaginary number unit of the synchronous code data.

10. The method of claim 6, wherein operation of the baseband data and synchronous code data is performed by using only one combination among combinations of multiplying real number unit or imaginary number unit of the baseband data with real number unit or imaginary number unit of the synchronous code data.
